(19) United States
(12) Patent Application Publication
(10) Pub. No.: US 2026/0075527 A1
(43) Pub. Date: Mar. 12, 2026

(54) WAKE-UP SIGNAL WITH OVERLAID CONTROL CHANNEL FOR WIRELESS COMMUNICATIONS

(71) Applicant: QUALCOMM Incorporated, San Diego, CA (US)

(72) Inventors: Weimin DUAN, San Diego, CA (US); Huilin XU, Temecula, CA (US); Jing LEI, San Diego, CA (US)

(21) Appl. No.: 18/883,516

(22) Filed: Sep. 12, 2024

(51) Int. Cl. H04W 52/02; H04L 5/00; H04L 27/26

(52) U.S. Cl. CPC H04W 52/0235; H04L 5/0007; H04L 5/0083; H04L 27/2653

(57) ABSTRACT

Methods, systems, and devices for wireless communications are described that provide for a user equipment (UE) that operates in a low-power mode and monitors for a low power wake-up signal (LP-WUS) to indicate that the UE is to transition from the low-power mode to a higher power mode. The UE may receive an on-off keying (OOK) LP-WUS that has control information overlaid on one or more OOK ON symbols. The control information may be carried in a physical downlink control channel (PDCCH) that is provided as an orthogonal frequency division multiplexing (OFDM)-based control channel signal that is overlaid on an OOK LP-WUS. Within each OOK-ON symbol, an entire or partial PDCCH may transmitted, depending on the OOK symbol duration and number of information bits of the PDCCH.

### FIELD OF TECHNOLOGY

The following relates to wireless communications, including wake-up signal with overlaid control channel for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a wake-up signal that uses on-off keying (OOK) modulation to indicate the UE is to transition from a lower power state to a higher power state, the wake-up signal including a set of multiple OOK symbols that include a set of multiple OOK-ON symbols and a set of multiple OOK-OFF symbols and decoding an orthogonal frequency division multiplexing (OFDM)-based control channel signal that is overlaid on one or more of the OOK-ON symbols.

A UE for wireless communications is described. The UE may include one or more memories storing processor executable code, and one or more processors coupled with the one or more memories. The one or more processors may individually or collectively be operable to execute the code to cause the UE to receive a wake-up signal that uses OOC modulation to indicate the UE is to transition from a lower power state to a higher power state, the wake-up signal including a set of multiple OOK symbols that include a set of multiple OOK-ON symbols and a set of multiple OOK-OFF symbols and decode an OFDM-based control channel signal that is overlaid on one or more of the OOK-ON symbols.

Another UE for wireless communications is described. The UE may include means for receiving a wake-up signal that uses OOC modulation to indicate the UE is to transition from a lower power state to a higher power state, the wake-up signal including a set of multiple OOK symbols that include a set of multiple OOK-ON symbols and a set of multiple OOK-OFF symbols and means for decoding an OFDM-based control channel signal that is overlaid on one or more of the OOK-ON symbols.

A non-transitory computer-readable medium storing code for wireless communications is described. The code may include instructions executable by one or more processors to receive a wake-up signal that uses OOC modulation to indicate the UE is to transition from a lower power state to a higher power state, the wake-up signal including a set of multiple OOK symbols that include a set of multiple OOK-ON symbols and a set of multiple OOK-OFF symbols and decode an OFDM-based control channel signal that is overlaid on one or more of the OOK-ON symbols.

In some examples of the method, UEs, and non-transitory computer-readable medium described herein, the decoding may include operations, features, means, or instructions for demodulating a set of wake-up signal subcarriers of the OOK-ON symbols to obtain a control channel signal, where a duration of each OOK-ON symbol corresponds to an OFDM symbol duration and decoding the control channel signal to obtain control information.

In some examples of the method, UEs, and non-transitory computer-readable medium described herein, the decoding may include operations, features, means, or instructions for demultiplexing a time domain signal transmitted using a set of wake-up signal subcarriers of the OOK-ON symbols to obtain a control channel signal and a demodulation reference signal, where a duration of each OOK-ON symbol is less than an OFDM symbol duration, and decoding the control channel signal from two or more OOK-ON symbol durations to obtain control information, where the control channel signal is demodulated based on the demodulation reference signal.

In some examples of the method, UEs, and non-transitory computer-readable medium described herein, the decoding may include operations, features, means, or instructions for demodulating a set of wake-up signal subcarriers of the OOK-ON symbols to obtain an OOK payload and a control channel signal, where a duration of each OOK-ON symbol is less than an OFDM symbol duration, and a subcarrier spacing on the set of wake-up signal subcarriers is based on a ratio between the duration of the OOK-ON symbols and the OFDM symbol duration and decoding the control channel signal to obtain control information.

In some examples of the method, UEs, and non-transitory computer-readable medium described herein, the OFDM-based control channel signal may be provided as a single carrier (SC) frequency division multiplexing (FDM) waveform.

In some examples of the method, UEs, and non-transitory computer-readable medium described herein, an OFDM symbol duration of the OFDM-based control channel signal is an integer multiple of an OOK symbol duration of the set of multiple OOK symbols, and the OFDM symbol duration and the OOK symbol duration provide for time alignment between the set of multiple OOK symbols of the wake-up signal and one or more other signals that are frequency division multiplexed with the wake-up signal. In some examples of the method, UEs, and non-transitory computer-readable medium described herein, a duration of each OOK-ON symbol corresponds to an OFDM symbol duration, and the OFDM-based control channel signal is transmitted in one OFDM symbol or multiple consecutive OFDM symbols of consecutive OOK-ON symbols. In some examples of the method, UEs, and non-transitory computer-readable medium described herein, a duration of each OOK-ON symbol is less than an OFDM symbol duration, and the OFDM-based control channel signal is transmitted in one or more OOK-ON symbols.

In some examples of the method, UEs, and non-transitory computer-readable medium described herein, the OFDM-based control channel signal includes control information encoded in a set of control channel elements (CCEs) that each include eleven resource blocks (RBs) in one OOK-ON symbol duration, where each resource block (RB) corresponds to a first quantity of subcarriers of one OON-ON symbol. In some examples of the method, UEs, and non-transitory computer-readable medium described herein, each CCE of the set of CCEs corresponds to time-frequency resources of one OOK-ON symbol in an allocated bandwidth of the wake-up signal without guard-band resources.

In some examples of the method, UEs, and non-transitory computer-readable medium described herein, each CCE of the set of CCEs includes a set of resource element groups (REGs) and first quantity of additional resource elements (REs), and the first quantity of additional REs contain fewer REs than each REG, and where a quantity of REGs in each CCE is based on a quantity of RBs in one OOK-ON symbol. In some examples of the method, UEs, and non-transitory computer-readable medium described herein, a quantity of REs in each REG is based on the quantity of RBs in one OOK-ON symbol.

A method for wireless communications by a network entity is described. The method may include generating a wake-up signal for at least a first UE, the wake-up signal using OOC modulation to indicate that the first UE is to transition from an idle state to an active state, where the wake-up signal includes a set of multiple OOK symbols that include a set of multiple OOK-ON symbols and a set of multiple OOK-OFF symbols, modulating an OFDM-based control channel signal onto a set of subcarriers of one or more of the OOK-ON symbols, and transmitting the wake-up signal and OFDM-based control channel signal to the first UE.

A network entity for wireless communications is described. The network entity may include one or more memories storing processor executable code, and one or more processors coupled with the one or more memories. The one or more processors may individually or collectively be operable to execute the code to cause the network entity to generate a wake-up signal for at least a first UE, the wake-up signal using OOC modulation to indicate that the first UE is to transition from an idle state to an active state, where the wake-up signal includes a set of multiple OOK symbols that include a set of multiple OOK-ON symbols and a set of multiple OOK-OFF symbols, modulate an OFDM-based control channel signal onto a set of subcarriers of one or more of the OOK-ON symbols, and transmit the wake-up signal and OFDM-based control channel signal to the first UE.

Another network entity for wireless communications is described. The network entity may include means for generating a wake-up signal for at least a first UE, the wake-up signal using OOC modulation to indicate that the first UE is to transition from an idle state to an active state, where the wake-up signal includes a set of multiple OOK symbols that include a set of multiple OOK-ON symbols and a set of multiple OOK-OFF symbols, means for modulating an OFDM-based control channel signal onto a set of subcarriers of one or more of the OOK-ON symbols, and means for transmitting the wake-up signal and OFDM-based control channel signal to the first UE.

A non-transitory computer-readable medium storing code for wireless communications is described. The code may include instructions executable by one or more processors to generate a wake-up signal for at least a first UE, the wake-up signal using OOC modulation to indicate that the first UE is to transition from an idle state to an active state, where the wake-up signal includes a set of multiple OOK symbols that include a set of multiple OOK-ON symbols and a set of multiple OOK-OFF symbols, modulate an OFDM-based control channel signal onto a set of subcarriers of one or more of the OOK-ON symbols, and transmit the wake-up signal and OFDM-based control channel signal to the first UE.

In some examples of the method, network entities, and non-transitory computer-readable medium described herein, the modulating may include operations, features, means, or instructions for modulating the set of subcarriers of one or more of the OOK-ON symbols with a control channel signal, where a duration of each OOK-ON symbol corresponds to an OFDM symbol duration. In some examples of the method, network entities, and non-transitory computer-readable medium described herein, time-domain multiplexing a control channel signal and a demodulation reference signal to generate a multiplexed control channel signal to be modulated onto the set of subcarriers of the one or more OOK-ON symbols.

In some examples of the method, network entities, and non-transitory computer-readable medium described herein, the modulating may include operations, features, means, or instructions for encoding control channel information to generate a control channel signal and modulating the control channel signal onto a set of wake-up signal subcarriers of the OOK-ON symbols, where a duration of each OOK-ON symbol is less than an OFDM symbol duration, and a subcarrier spacing on the set of wake-up signal subcarriers is based on a ratio between the duration of the OOK-ON symbols and the OFDM symbol duration.

In some examples of the method, network entities, and non-transitory computer-readable medium described herein, the OFDM-based control channel signal may be provided as a SC-FDM waveform.

In some examples of the method, network entities, and non-transitory computer-readable medium described herein, an OFDM symbol duration of the OFDM-based control channel signal is an integer multiple of an OOK symbol duration of the set of multiple OOK symbols, and the OFDM symbol duration and the OOK symbol duration provide for time alignment between the set of multiple OOK symbols of the wake-up signal and one or more other signals that are frequency division multiplexed with the wake-up signal. In some examples of the method, network entities, and non-transitory computer-readable medium described herein, a duration of each OOK-ON symbol corresponds to an OFDM symbol duration, and the OFDM-based control channel signal is transmitted in one OFDM symbol or multiple consecutive OFDM symbols of consecutive OOK-ON symbols. In some examples of the method, network entities, and non-transitory computer-readable medium described herein, a duration of each OOK-ON symbol is less than an OFDM symbol duration, and the OFDM-based control channel signal is transmitted in one or more OOK-ON symbols.

In some examples of the method, network entities, and non-transitory computer-readable medium described herein, the OFDM-based control channel signal includes control information encoded in a set of CCEs that each include eleven RBs in one OOK-ON symbol duration, where each RB corresponds to a first quantity of subcarriers of one OON-ON symbol. In some examples of the method, network entities, and non-transitory computer-readable medium described herein, each CCE of the set of CCEs corresponds to time-frequency resources of one OOK-ON symbol in an allocated bandwidth of the wake-up signal without guard-band resources.

In some examples of the method, network entities, and non-transitory computer-readable medium described herein, each CCE of the set of CCEs includes a set of REGs and first quantity of additional REs, and the first quantity of additional REs contain fewer REs than each REG, and where a quantity of REGs in each CCE may be based on a quantity of RBs in one OOK-ON symbol. In some examples of the method, network entities, and non-transitory computer-readable medium described herein, a quantity of REs in each REG may be based on the quantity of RBs in one OOK-ON symbol.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports wake-up signals with overlaid control channel for wireless communications in accordance with one or more aspects of the present disclosure.

FIG. 2 shows an example of a wireless communications system that supports wake-up signals with overlaid control channel for wireless communications in accordance with one or more aspects of the present disclosure.

FIG. 3 shows an example of a timing diagram that supports wake-up signals with overlaid control channel for wireless communications in accordance with one or more aspects of the present disclosure.

FIG. 4 shows an example of a signal processing technique that supports wake-up signals with overlaid control channel for wireless communications in accordance with one or more aspects of the present disclosure.

FIG. 5 shows an example of a control channel element that supports wake-up signals with overlaid control channel for wireless communications in accordance with one or more aspects of the present disclosure.

FIGS. 6 and 7 show block diagrams of devices that support wake-up signal with overlaid control channel for wireless communications in accordance with one or more aspects of the present disclosure.

FIG. 8 shows a block diagram of a communications manager that supports wake-up signals with overlaid control channel for wireless communications in accordance with one or more aspects of the present disclosure.

FIG. 9 shows a diagram of a system including a device that supports wake-up signals with overlaid control channel for wireless communications in accordance with one or more aspects of the present disclosure.

FIGS. 10 and 11 show block diagrams of devices that support wake-up signal with overlaid control channel for wireless communications in accordance with one or more aspects of the present disclosure.

FIG. 12 shows a block diagram of a communications manager that supports wake-up signals with overlaid control channel for wireless communications in accordance with one or more aspects of the present disclosure.

FIG. 13 shows a diagram of a system including a device that supports wake-up signals with overlaid control channel for wireless communications in accordance with one or more aspects of the present disclosure.

FIGS. 14 through 18 show flowcharts illustrating methods that support wake-up signal with overlaid control channel for wireless communications in accordance with one or more aspects of the present disclosure.

### DETAILED DESCRIPTION

Wireless networks may adopt various techniques and technologies to conserve power. One such example power saving technique may include use of a low-power wakeup radio (LP-WUR) at a user equipment (UE) that may be used in lieu of a main radio (MR) when the UE is in a lower power state, such as a sleep state. For example, the LP-WUR may be used to monitor for low-power wakeup signal (LP-WUS) or low-power synchronization signal (LP-SS) transmissions. The LP-WUS transmissions may carry or otherwise convey an indication of whether the UE needs to transition to another state, such as a higher power state or an awake state, and power up the MR to perform wireless communications with a network. Such low-power (LP) signal transmissions may use on-off keying (OOK) modulation for low-complexity envelope detection by the LP-WUR. A LP-WUR may be a low-complexity and low power radio that can detect an OOK LP-WUS and then turn on other components of the UE for subsequent communications. In some UEs, the LP-WUR may be an in-phase/quadrature (I/Q)-based radio that has a lower noise floor (NF) and higher processing gain then a simple OOK-based radio, which can substantially enhance reliability of receiving the WUS while still providing relatively low-cost and low-power WUR.

In some wireless communications systems, a network entity may transmit a LP-WUS to a UE to trigger physical downlink control channel (PDCCH) monitoring at the UE. When the UE is in a connected mode, reception of the LP-WUS may trigger the UE to monitor for all configured PDCCHs. In such cases, the network entity may double the resources and energy for sending control information, because the network entity may transmit the LP-WUS in order to transmit a PDCCH. Because the LP-WUS uses a non-coherent OOK modulation, the LP-WUS may use additional resources to enable a lower data rate for the UE to successfully detect the LP-WUS. Moreover, transmitting an LP-WUS for every PDCCH to be transmitted may cause additional latency. It may be desirable to enhance efficiency in wireless resource usage, reduce latency, and further reduce power consumption associated with LP-WUS power saving techniques.

According to some aspects described herein, a UE may receive an orthogonal frequency division multiplexing (OFDM)-based control channel signal (e.g., PDCCH signaling) that is overlaid on an OOK LP-WUS. In some aspects, UEs may implement I/Q-based LP-WURs, which may allow for more complex signaling to be overlaid on LP-WUSs, such as PDCCH signaling. In some aspects, a LP-WUS may provide for joint transmission of OFDM-based PDCCH and OOK LP-WUS. Within each OOK-ON symbol, an entire or partial PDCCH may transmitted, depending on the OOK symbol duration and number of information bits of the PDCCH. In some aspects, an OOK symbol duration may correspond to an OFDM symbol duration, and the overlaid PDCCH is modulated in the frequency domain over the allocated LP-WUS subcarriers directly. In some other aspects, multiple OOK symbols may be included in one OFDM symbol duration, and to maintain the OOK pattern and bandwidth of the LP-WUS, the overlaid PDCCH may be a time domain signal and associated demodulation reference signal (DMRS) that is time division multiplexed (TDM'ed) with information, or the overlaid PDCCH may be modulated in the frequency domain with a subcarrier spacing (SCS) that is based on a quantity of OOK symbols within one OFDM symbol to provide a mixed numerology-based solution. In some aspects, the PDCCH structure for the overlaid PDCCH may also be designed to provide efficient signaling of PDCCH information on LP-WUS subcarriers. For example, the LP-WUS may be transmitted in a 5 MHz bandwidth that, based on a 30 kHz SCS, provides 11 resource blocks (RBs), and a PDCCH overlaid on the LP-WUS can have a non-integer quantity of resource element groups (REGs) in a control channel element (CCE) (e.g., 5.5 REGs in a CCE).

Particular aspects of the subject matter described herein may be implemented to realize one or more potential advantages. The described techniques may provide for reduced processing, reduced power consumption, reduced latency, improved user experience related to reduced processing, more efficient utilization of communication resources, improved coordination between devices, and longer battery life. For example, the UE may reduce power consumption by receiving control information via a LP-WUS using a LP-WUR rather than having to receive such information via a separate PDCCH transmission from the LP-WUS. Additionally, or alternatively, the network entity may reduce power consumption by outputting fewer PDCCH transmissions relative to other techniques.

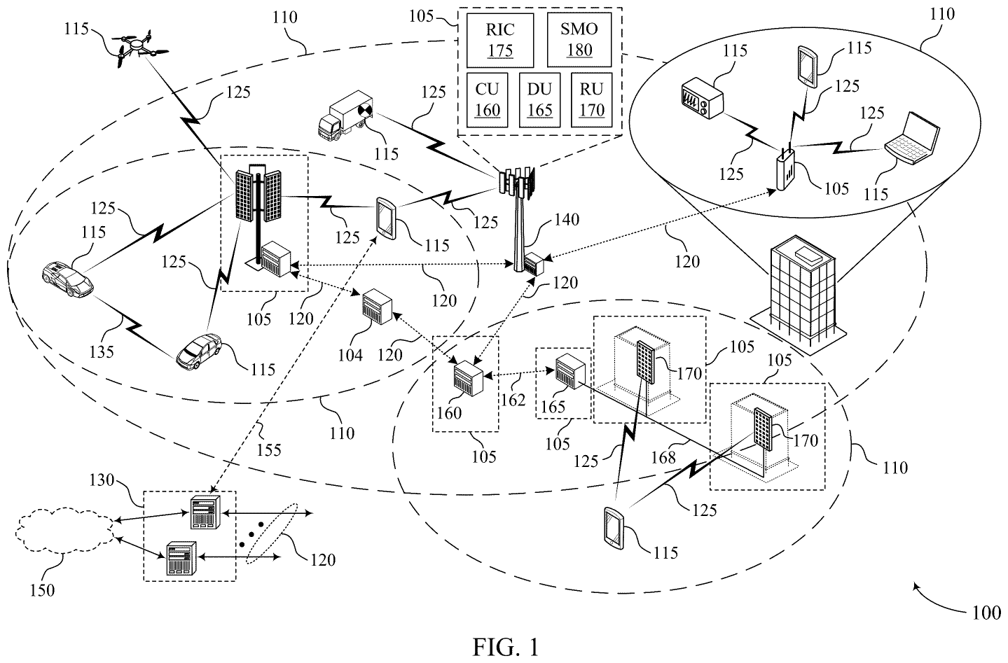

FIG. 1 shows an example of a wireless communications system 100 that supports wake-up signals with overlaid control channel for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions.

Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, some UEs 115 may operate in a low-power mode and monitor for a LP-WUS to indicate that the UE 115 is to transition from the low-power mode to a higher power mode. Such UEs 115 may receive a LP signal transmission using a low-power wake-up radio (LP-WUR) from one or more network entities 105 as an OOK LP-WUS. In accordance with various aspects, a UE 115 may receive an OFDM-based control channel signal (e.g., PDCCH signaling) that is overlaid on an OOK LP-WUS. In some aspects, within each OOK-ON symbol, an entire or partial PDCCH may transmitted, depending on the OOK symbol duration and number of information bits of the PDCCH. In some aspects, an OOK symbol duration may correspond to an OFDM symbol duration, and the overlaid PDCCH is modulated in the frequency domain over the allocated LP-WUS subcarriers directly. In other aspects, multiple OOK symbols may be included in one OFDM symbol duration, and to maintain the OOK pattern and bandwidth of the LP-WUS, the overlaid PDCCH may be a time domain signal and associated DMRS that is TDM'ed with information, or the overlaid PDCCH may be modulated in the frequency domain with a SCS that is based on a quantity of OOK symbols within one OFDM symbol to provide a mixed numerology-based solution. In some aspects, the PDCCH structure for the overlaid PDCCH may also be designed to provide efficient signaling of PDCCH information on LP-WUS subcarriers. For example, the LP-WUS may be transmitted in a 5 MHz bandwidth that, based on a 30 kHz SCS, provides 11 RBs, and a PDCCH overlaid on the LP-WUS can have a non-integer quantity of REGs in a CCE (e.g., 5.5 REGs in a CCE).

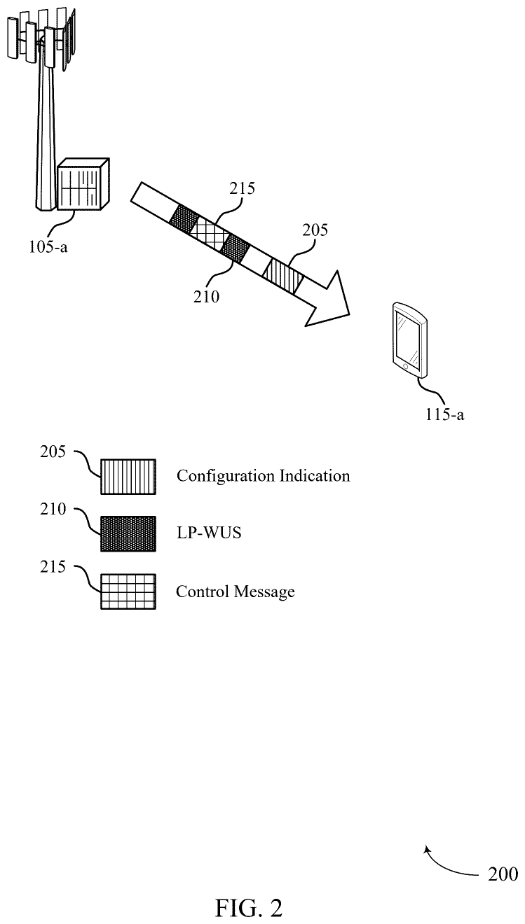

FIG. 2 shows an example of a wireless communications system 200 that supports wake-up signals with overlaid control channel for wireless communications in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115-and a network entity 105, it is understood that the described techniques may be performed by a wireless device different from a UE 115-and a network entity 105. As described herein, operations performed by the UE 115-a and the network entity 105-a may be respectively performed by a UE 115, a network entity 105, or another wireless device, and the examples shown should not be construed as limiting.

In some examples, a network entity 105-a may output or transmit a wake-up signal to a UE 115-a to trigger the UE 115-a to transition from a low-power mode to a higher power mode. A wake-up signal may be termed a low-power wake-up signal (LP-WUS) when the signaling design considers a relatively simple receiver architecture, and may be associated with a basic modulation scheme of OOK. That is, the UE 115 may include at least two radios: a main radio (MR) and a low-power wake-up radio (LP-WUR) (e.g., an I/Q-based radio that provides for envelope detection of an OOK WSU). The LP-WUR may be simplified receiver circuitry that the UE 115-a may use to monitor for and detect an LP-WUS. Since the LP-WUR may lack one or more other receiving capabilities and consume less power, the UE 115-a may save power by operating in a relatively low power state (e.g., a first power state) using the LP-WUR without operating more power-intensive circuitry including the MR. In contrast, the UE 115 may use the MR while in a relatively high power state (e.g., a second power state) to increase receive functionality at the cost of increased power consumption, such as for monitoring for PDSCH transmissions. In some examples, the network entity 105 may trigger, such as by sending a LP-WUS 210 the UE 115-a to transition from the first power state to the second power state (e.g., wake up by transitioning from using the LP-WUR to using the MR). In some aspects, the network entity 105-a may transmit configuration information 205 to UE 115-a that indicates a configuration for LP-WUS 210, which may include a control message 215 (e.g., a PDCCH).

In some aspects, the control message may be an OFDM-based control channel signal (e.g., PDCCH signaling) that is overlaid on OOK-ON symbols of LP-WUS 210, to provide for joint transmission of OFDM-based PDCCH and OOK LP-WUS. In some cases, within each OOK-ON symbol, an entire or partial PDCCH may transmitted, depending on the OOK symbol duration and number of information bits of the PDCCH. In cases where an OOK symbol duration matches an OFDM symbol duration, the overlaid PDCCH may be modulated in the frequency domain over the allocated LP-WUS subcarriers directly. In cases where multiple OOK symbols are included in the OFDM symbol duration, to maintain the OOK pattern and bandwidth of the LP-WUS, the overlaid PDCCH may be provided using one of two options. A first option is that an overlaid PDCCH is a time domain signal and an associated DMRS is TDM'ed with control information. A second option is to provide a mixed numerology-based solution where the overlaid PDCCH can be modulated in the frequency domain with an SCS that is based on a quantity of OOK symbols within one OFDM symbol (e.g., if the OFDM symbol duration is 1/B_{scs}, the SCS for the overlaid PDCCH can be M*B_{SCS}, where M is a quantity of OOK symbols within one OFDM symbol).

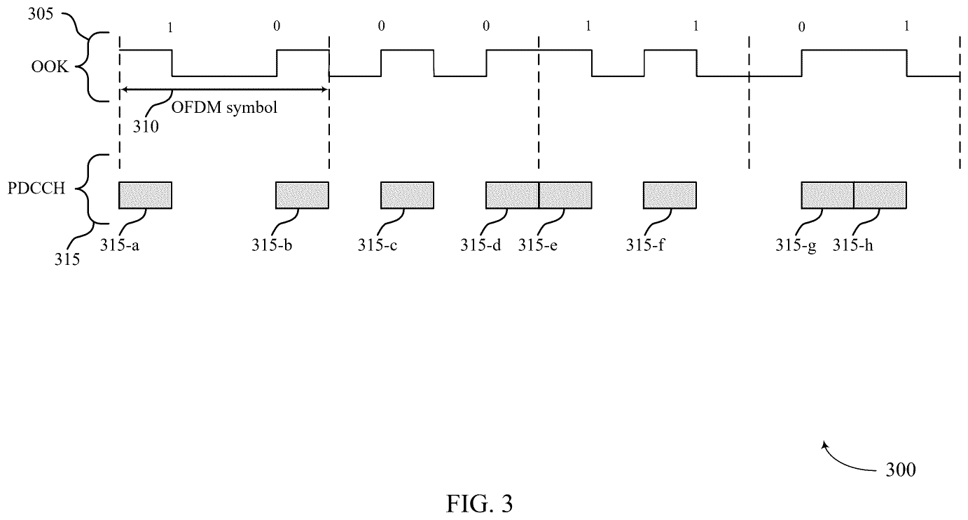

In some aspects, a PDCCH structure for the overlaid PDCCH may provide efficient signaling of PDCCH information on LP-WUS subcarriers. In traditional PDCCH communications, the basic resource unit for PDCCH is a control channel element (CCE) which contains 6 RBs in one symbol (6 REGs). However, the LP-WUS 210 may be designed to be transmitted in a 5 MHz bandwidth that, based on a 30 kHz SCS (e.g., to match synchronization signals of a synchronization signal block (SSB) in 5G systems), would provide 11 RBs. In accordance with various aspects, control message 215 (e.g., a PDCCH) overlaid on the LP-WUS 210 may have a unique definition for CCEs (e.g., a CCE can be defined as resources within 11 RBs in one symbol), definitions for a non-integer number of REGs in a CCE (e.g., 5.5 REGs in a CCE), and definitions for quantities of REs in each REG (e.g., 11 REs in one OFDM symbol, such that 11 RBs can map to 12 REGs within a single OOK-ON symbol). FIGS. 3 through 5 illustrate aspects of OFDM-based control message 215 transmission with a LP-WUS 210.

FIG. 3 shows an example of a timing diagram 300 that supports wake-up signals with overlaid control channel for wireless communications in accordance with one or more aspects of the present disclosure. The timing diagrams 300 may implement or be implemented by one or more aspects of the wireless communications system 100 and the wireless communications system 200 described with reference to FIGS. 1 and 2, respectively. For example, the timing diagram 300 may be implemented by a network entity 105 and a UE 115 as described with reference to FIGS. 1 and 2 to support reduced power consumption through implementation of a LP-WUS.

For example, the timing diagram 300 illustrates an OOK signal 305 that may have a PDCCH 315 that is overlaid on OOK ON symbols. In this example, four OOK symbols may be included in an OFDM symbol 310 duration (e.g., M=4), and a transition from an OOK ON symbol to an OOK OFF symbol may indicate a value of ‘1’ with a transition from an OOF OFF symbol to an OOK ON symbol indicating a value of ‘0’. In accordance with various aspects discussed herein, in each OOK ON symbol duration, a PDCCH 315 transmission is overlaid, thus providing a first PDCCH 315-a through an eighth PDCCH 315-h overlaid on corresponding OOK ON symbols.

In each OOK ON symbol, a preconfigured sequence may be transmitted that can additionally carry the LP-WUS information. In some aspects, the overlaid sequence may be an OFDM signal that uses a full bandwidth transmission in the allocated LP-WUS bandwidth, uses a higher sampling rate with respect to the OOK symbol rate, and has relatively flat spectrum such that the overlaid sequence allows for non-coherent envelope detection of OOK modulated LP-WUS of the OOK signal 305. In some aspects, an I/Q receiver-based LP-WUR may detect the overlaid sequence in time domain without FFT, or in frequency domain with FFT.

Thus, in some aspects, the OOK signal 305 carries wakeup information and PDCCH 315 information. The PDCCH 315 may include, for example, a paging PDCCH or paging early indication (PEI) for idle and inactive modes and the PDCCH based WUS (e.g., Downlink Control Information of Power Saving—DCP in DCI format 2_6) to activate a DRX On-Duration timer for a connected mode UE. In some aspects, transmission of the PDCCH 315 overlaid on the OOK signal 305 may not use extra resource overhead and hence is more resource and energy efficient. Further, from the UE perspective, it may facilitate a low power PDCCH design and hardware implementation of a small modem for UE power saving.

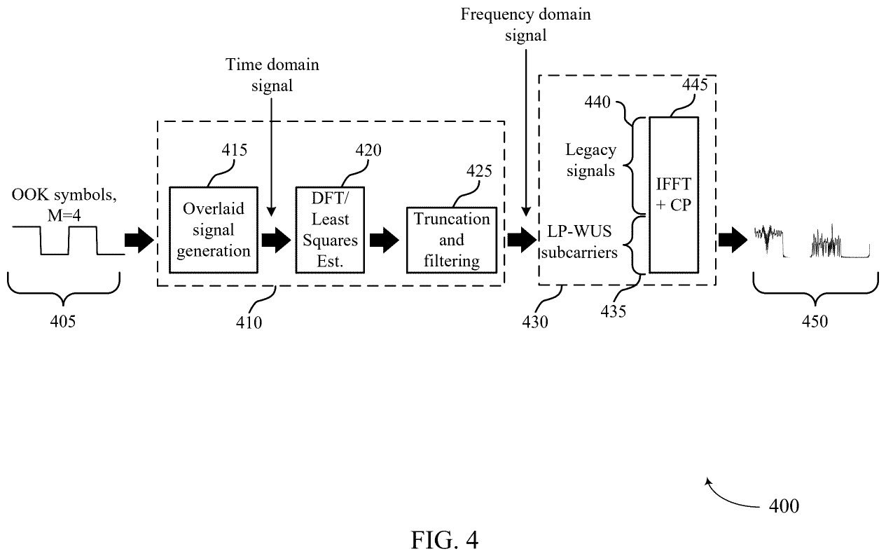

In some examples, the OOK signal 305 may be an OOK LP-WUS that uses an OOK waveform envelope to carry the WUS information. Within each OOK ON symbol, the entire or partial PDCCH 315 is transmitted depending on the OOK symbol duration and number of information bits of the PDCCH. In the example, of FIG. 3, M=4 OOK ON/OFF symbols transmitted in each OFDM symbol 310 duration. In some examples, the OFDM symbol 310 duration may be used as the basic time unit to ensure the time alignment between LP-WUS and other legacy signals that are frequency division multiplexed (FDM'ed) with the LP-WUS. However, in other examples the OFDM symbol duration may simply be defined as a reference time unit. In some examples, when M=1, that is, the OOK ON/OFF symbol duration matches the OFDM symbol 310 duration, the overlaid PDCCH 315 can be modulated in the frequency domain over the allocated LP-WUS subcarriers directly. In other examples, when M>1, that is, the OOK ON/OFF symbol duration is smaller than the OFDM symbol duration, techniques such as discussed with reference to FIG. 4 may be used to provide the overlaid PDCCH 315.

FIG. 4 shows an example of a signal processing technique 400 that supports wake-up signals with overlaid control channel for wireless communications in accordance with one or more aspects of the present disclosure. The signal processing technique 400 may implement or be implemented by one or more aspects of the wireless communications system 100 and the wireless communications system 200 described with reference to FIGS. 1 and 2, respectively, or the timing diagram 300 of FIG. 3. For example, the signal processing technique 400 may be implemented by a network entity 105 and a UE 115 as described with reference to FIGS. 1 and 2 to support reduced power consumption through implementation of a LP-WUS.

In the example of FIG. 4, and OOK signal 405 may be provided with M>1 (e.g., M=4). Time domain processing 410 may provide that PDCCH information is overlaid on OOK ON symbols, and may include overlaid signal generation 415 to generate a time domain PDCCH signal. A discrete Fourier transform (DFT) or least squares estimator 420 may provide a frequency domain representation of the time domain PDCCH signal that may have truncation and filtering 425 applied, to generate a frequency domain signal that is provided for frequency domain processing 430. The frequency domain signal may be provided to an inverse fast Fourier transform and cyclic prefix (CP) function 445 that generates an OOK signal 450 in which OOK ON symbols are overlaid with an OFDM signal, with LP-WUS subcarriers 435 and legacy signals 440. Thus, when M>1 and the OOK ON/OFF symbol duration is smaller than the OFDM symbol duration, to maintain the OOK pattern and bandwidth of the LP-WUS, the overlaid PDCCH may be a time domain signal, and an associated DMRS is TDM'ed with PDCCH information. In the example of FIG. 4, the overlaid signal may corresponds to a single carrier frequency domain modulated (SC-FDM) waveform. Note that for M=1, the overlaid PDCCH can also be generated in SC-FDM waveform. In other examples, a mixed numerology-based solution may be provided, in which the overlaid PDCCH can be modulated in the frequency domain with a large SCS. For example, if the OFDM symbol duration is 1/B_{scs}, the SCS for the overlaid PDCCH can be M*B_{SCS}.

In some aspects, when M=1, the PDCCH can be transmitted in one OFDM symbol or multiple consecutive OFDM symbols with the OOK ON state. When M>1, the PDCCH can be transmitted in one OOK ON symbol or multiple OOK ON symbols. In some examples, when Manchester coding is adopted, up to 2 OFDM symbols in an ON state or OOK ON symbols may be adjacent, without OFF state in between. Further, when Manchester coding is not adopted, there can be more than 2 adjacent OFDM symbols in the ON state or OOK ON symbols.

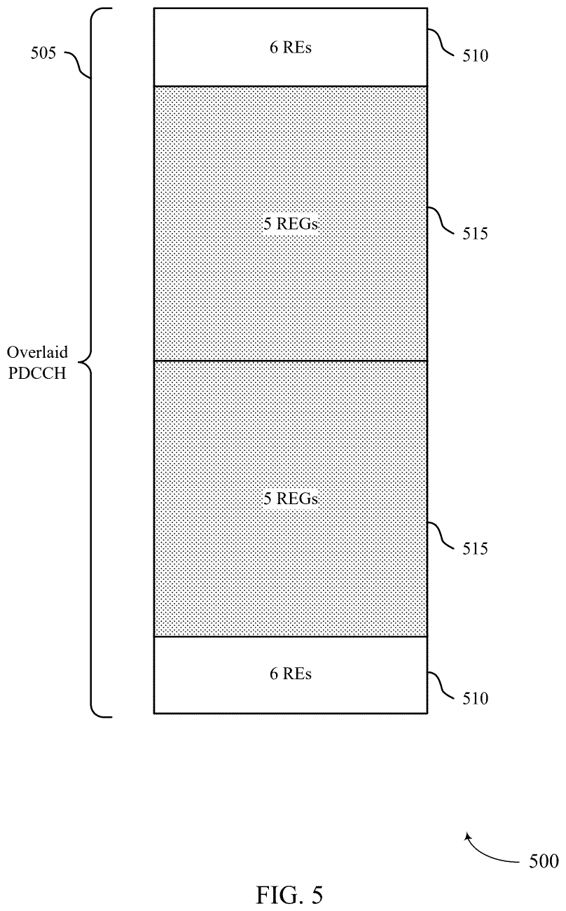

FIG. 5 shows an example of a control channel element 500 that supports wake-up signals with overlaid control channel for wireless communications in accordance with one or more aspects of the present disclosure. The control channel element 500 may implement or be implemented by one or more aspects of the wireless communications system 100 and the wireless communications system 200 described with reference to FIGS. 1 and 2, respectively, the timing diagram 300 of FIG. 3, or the signal processing technique 400 of FIG. 4. For example, the control channel element 500 may be implemented by a network entity 105 and a UE 115 as described with reference to FIGS. 1 and 2 to support reduced power consumption through implementation of a LP-WUS.

In some aspects, an LP-WUS may be implemented if existing systems that provide a known frequency grid for resource block allocations. For example, some 5G systems provide a 6 RB frequency grid for PDCCH resource allocation. However, a LP-WUS may not support such a frequency grid for PDCCH resource allocation. For example, a LP-WUS may be transmitted in a 5 MHz bandwidth including guard RBs at least for SCS 30 kHz, which may match a bandwidth of a primary synchronization signal (PSS) and secondary synchronization signal (SSS) of a SSB. In such systems, if one guard RB is reserved on each side of the LP-WUS bandwidth, 11 RBs will be used for LP-WUS transmission. For a SCS 1 of 5 kHz, the number of RBs for LP-WUS without guard RBs may be 11 or 22 depending on whether the same bandwidth or same number of RBs is used between SCS 15 kHz and 30 kHz. In some cases, use of 22 RBs may allow for overlaid sequences to be used across different SCS and M combinations.

In traditional systems, the basic resource unit for PDCCH is a control channel element (CCE) which contains 6 RBs in one symbol (6 REGs). Hence such a CCE may not be directly applied to the overlaid PDCCH in LP-WUS. Further, for M>1, if the PDCCH is transmitted in an SC-FDM waveform, it may be unclear how to interpret the CCE. In accordance with various aspects, a CCE may be defined for PDCCH overlaid on an OOK LP-WUS signal. In some examples, for M=1 with frequency domain PDCCH modulation, a CCE can be defined as resources within 11 RBs in one OFDM symbol. In other examples, when M>1 with frequency domain PDCCH modulation, a CCE can be defined as resources within 11 RBs in one OOK ON symbol, with a number of RBs defined in accordance with the numerology of OFDM SCS. In examples that use time domain PDCCH modulation, a CCE can be defined as one OOK ON symbol in the allocated bandwidth without guard RBs.

In the example of FIG. 5, an overlaid PDCCH 505 may be provided in a CCE that corresponds to 5.5 REGs, with 5 REGs 515 and 6 REs 510. In this example, CCEs with 5.5 REGs are illustrated for a total of 11 RB for overlaid PDCCH 505. Thus, a special CCE dedicated for overlaid PDCCH could be 5.5 REGs, where the edge of the CCE is with half REG (6 REs). Accordingly, in some aspects, a definition of Resource-Element group (REG) for overlaid PDCCH may be provided that is based on the RBs of an OOK ON symbol. For example, such a definition may provide each REG is with 11 REs with one OFDM symbol, and thus 11 RB may be used to map to 12 REGs within a single OOK ON symbol. In some cases, the CCE size may be defined as 3/4/6 REGs.

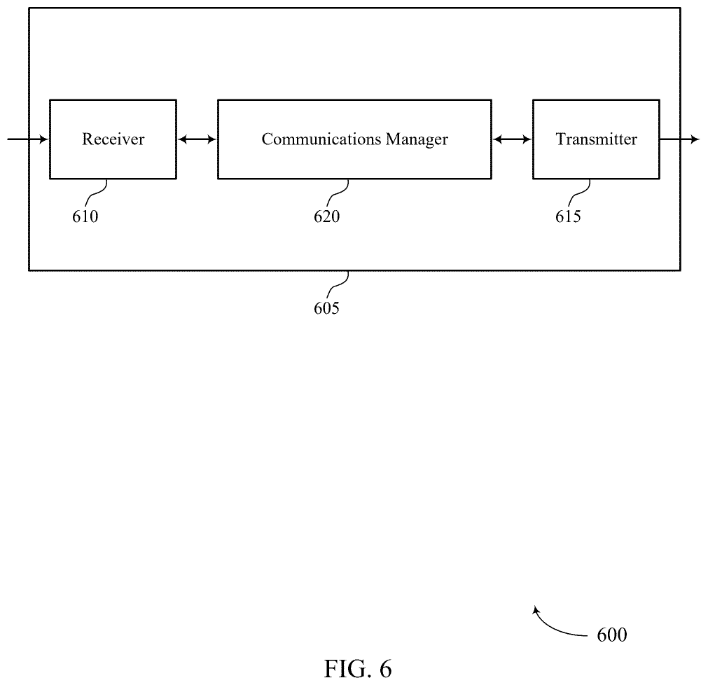

FIG. 6 shows a block diagram 600 of a device 605 that supports wake-up signals with overlaid control channel for wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to wake-up signal with overlaid control channel for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to wake-up signal with overlaid control channel for wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of wake-up signal with overlaid control channel for wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a wake-up signal that uses OOK modulation to indicate the UE is to transition from a lower power state (e.g., a sleep mode or a low power mode) to a higher power state (e.g., an active mode), the wake-up signal including a set of multiple OOK symbols that include a set of multiple OOK-ON symbols and a set of multiple OOK-OFF symbols. The communications manager 620 is capable of, configured to, or operable to support a means for decoding an OFDM-based control channel signal that is overlaid on one or more of the OOK-ON symbols.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

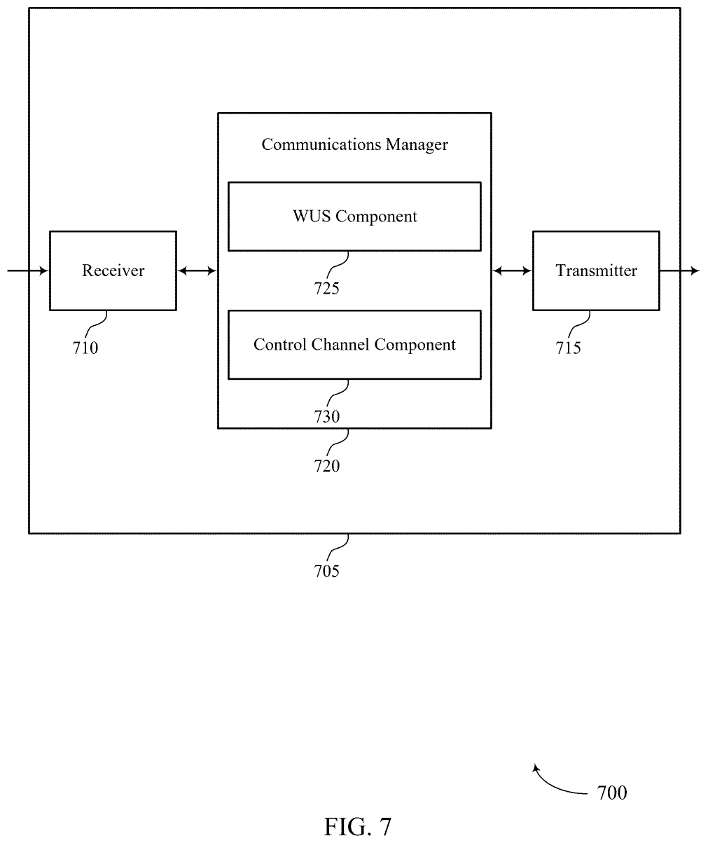

FIG. 7 shows a block diagram 700 of a device 705 that supports wake-up signals with overlaid control channel for wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to wake-up signal with overlaid control channel for wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to wake-up signal with overlaid control channel for wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of wake-up signal with overlaid control channel for wireless communications as described herein. For example, the communications manager 720 may include a WUS component 725 a control channel component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The WUS component 725 is capable of, configured to, or operable to support a means for receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The control channel component 730 is capable of, configured to, or operable to support a means for decoding an OFDM-based control channel signal that is overlaid on one or more of the OOK-ON symbols.

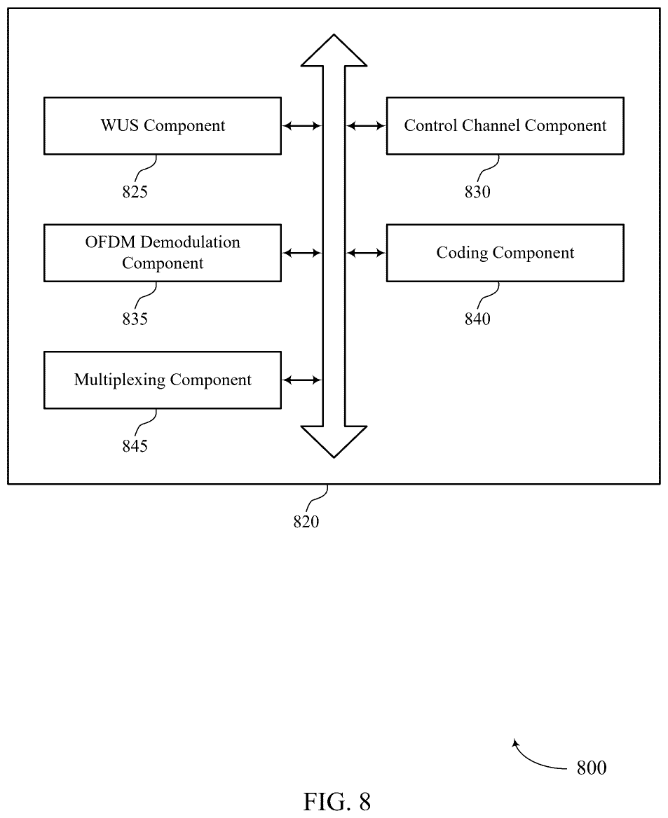

FIG. 8 shows a block diagram 800 of a communications manager 820 that supports wake-up signals with overlaid control channel for wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of wake-up signal with overlaid control channel for wireless communications as described herein. For example, the communications manager 820 may include a WUS component 825, a control channel component 830, an OFDM demodulation component 835, a coding component 840, a multiplexing component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The WUS component 825 is capable of, configured to, or operable to support a means for receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The control channel component 830 is capable of, configured to, or operable to support a means for decoding an OFDM-based control channel signal that is overlaid on one or more of the OOK-ON symbols.

In some examples, to support decoding, the OFDM demodulation component 835 is capable of, configured to, or operable to support a means for demodulating a set of wake-up signal subcarriers of the OOK-ON symbols to obtain a control channel signal, where a duration of each OOK-ON symbol corresponds to an OFDM symbol duration. In some examples, to support decoding, the coding component 840 is capable of, configured to, or operable to support a means for decoding the control channel signal to obtain control information.

In some examples, to support decoding, the multiplexing component 845 is capable of, configured to, or operable to support a means for demultiplexing a time domain signal transmitted using a set of wake-up signal subcarriers of the OOK-ON symbols to obtain a control channel signal and a demodulation reference signal, where a duration of each OOK-ON symbol is less than an OFDM symbol duration. In some examples, to support decoding, the OFDM demodulation component 835 is capable of, configured to, or operable to support a means for demodulating the modulated control channel signal based on the demodulation reference signal to obtain a control channel signal. In some examples, to support decoding, the coding component 840 is capable of, configured to, or operable to support a means for decoding the encoded control channel signal from two or more OOK-ON symbol durations to obtain control information.

In some examples, to support decoding, the OFDM demodulation component 835 is capable of, configured to, or operable to support a means for demodulating a set of wake-up signal subcarriers of the OOK-ON symbols to obtain a control channel signal, where a duration of each OOK-ON symbol is less than an OFDM symbol duration, and a subcarrier spacing on the set of wake-up signal subcarriers is based on a ratio between the duration of the OOK-ON symbols and the OFDM symbol duration. In some examples, to support decoding, the coding component 840 is capable of, configured to, or operable to support a means for decoding the control channel signal to obtain control information.

In some examples, the OFDM-based control channel signal is provided as a single carrier (SC) frequency division multiplexing (FDM) waveform. In some examples, an OFDM symbol duration of the OFDM-based control channel signal is an integer multiple of an OOK symbol duration of the set of multiple OOK symbols, and the OFDM symbol duration and the OOK symbol duration provide for time alignment between the set of multiple OOK symbols of the wake-up signal and one or more other signals that are frequency division multiplexed with the wake-up signal.

In some examples, a duration of each OOK-ON symbol corresponds to an OFDM symbol duration, and the OFDM-based control channel signal is transmitted in one OFDM symbol or multiple consecutive OFDM symbols of consecutive OOK-ON symbols. In some examples, a duration of each OOK-ON symbol is less than an OFDM symbol duration, and the OFDM-based control channel signal is transmitted in one or more OOK-ON symbols.

In some examples, the OFDM-based control channel signal includes control information encoded in a set of CCEs that each include eleven RBs in one OOK-ON symbol duration, where each RB corresponds to a first quantity of subcarriers of one OON-ON symbol. In some examples, each CCE of the set of CCEs corresponds to time-frequency resources of one OOK-ON symbol in an allocated bandwidth of the wake-up signal without guard-band resources. In some examples, each CCE of the set of CCEs includes a set of resource element groups (REGs) and first quantity of additional resource elements (REs), and the first quantity of additional REs contain fewer REs than each REG, and where a quantity of REGs in each CCE is based on a quantity of RBs in one OOK-ON symbol. In some examples, a quantity of REs in each REG is based on the quantity of RBs in one OOK-ON symbol.

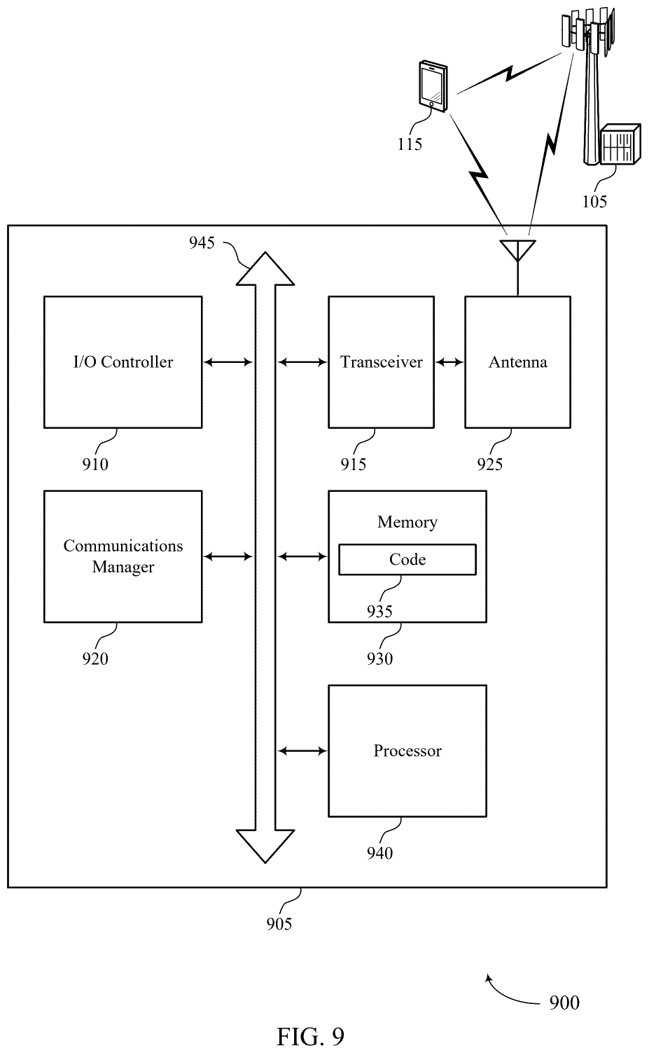

FIG. 9 shows a diagram of a system 900 including a device 905 that supports wake-up signals with overlaid control channel for wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting wake-up signal with overlaid control channel for wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The communications manager 920 is capable of, configured to, or operable to support a means for decoding an OFDM-based control channel signal that is overlaid on one or more of the OOK-ON symbols.

By including or configuring the communications manager 920 in accordance with examples as described herein, the device 905 may support techniques for reduced latency, improved user experience related to reduced processing, reduced power consumption, more efficient utilization of communication resources, improved coordination between devices, and longer battery life.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of wake-up signal with overlaid control channel for wireless communications as described herein, or the at least one processor 940 and the at least one memory 930 may be otherwise configured to, individually or collectively, perform or support such operations.

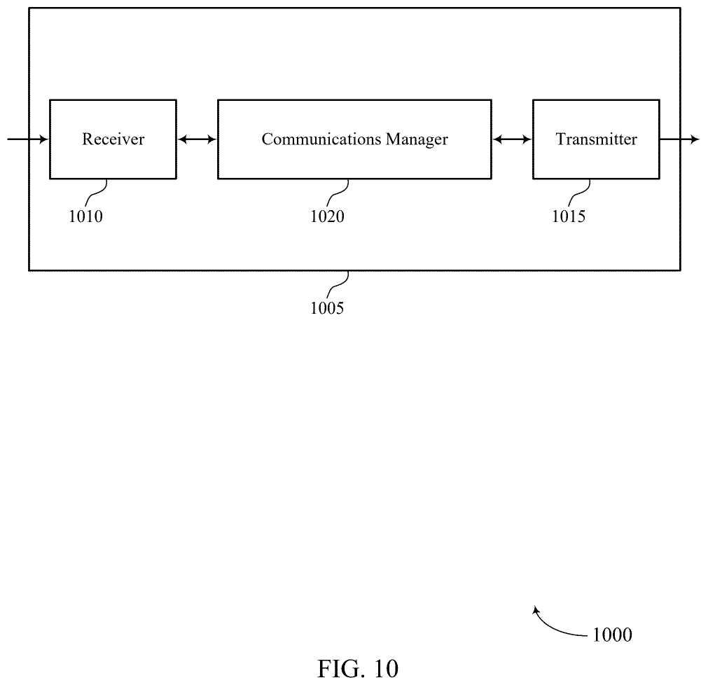

FIG. 10 shows a block diagram 1000 of a device 1005 that supports wake-up signals with overlaid control channel for wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of wake-up signal with overlaid control channel for wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for generating a wake-up signal for at least a first UE, the wake-up signal using OOK modulation to indicate that the first UE is to transition from a lower power state to a higher power state, where the wake-up signal includes a set of multiple OOK symbols that include a set of multiple OOK-ON symbols and a set of multiple OOK-OFF symbols. The communications manager 1020 is capable of, configured to, or operable to support a means for modulating an OFDM-based control channel signal onto a set of subcarriers of one or more of the OOK-ON symbols. The communications manager 1020 is capable of, configured to, or operable to support a means for transmitting the wake-up signal and OFDM-based control channel signal to the first UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

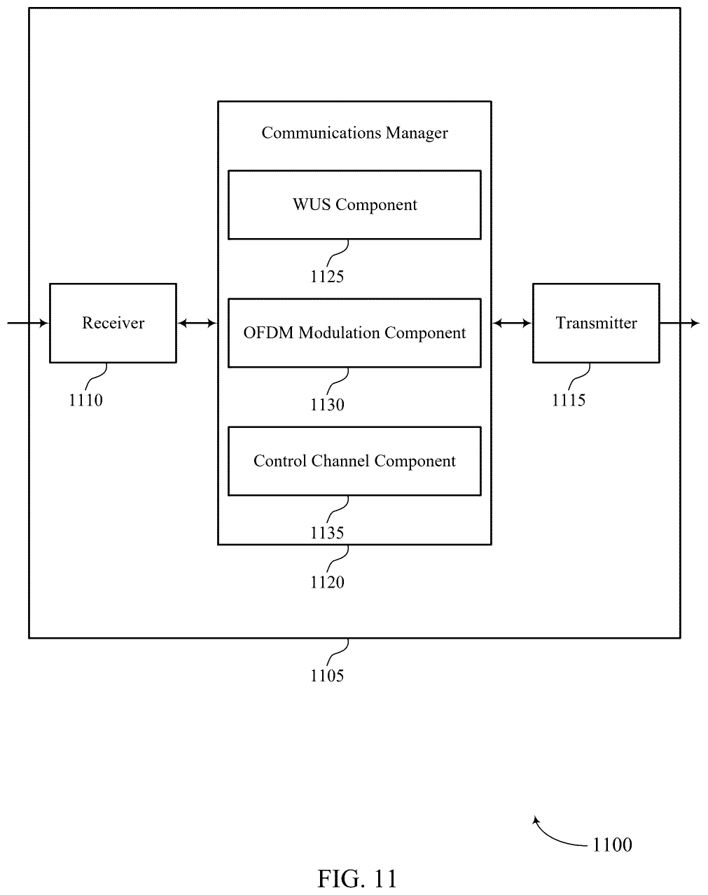

FIG. 11 shows a block diagram 1100 of a device 1105 that supports wake-up signals with overlaid control channel for wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of wake-up signal with overlaid control channel for wireless communications as described herein. For example, the communications manager 1120 may include a WUS component 1125, an OFDM modulation component 1130, a control channel component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The WUS component 1125 is capable of, configured to, or operable to support a means for generating a wake-up signal for at least a first UE, the wake-up signal using OOK modulation to indicate that the first UE is to transition from a lower power state to a higher power state, where the wake-up signal includes a set of multiple OOK symbols that include a set of multiple OOK-ON symbols and a set of multiple OOK-OFF symbols. The OFDM modulation component 1130 is capable of, configured to, or operable to support a means for modulating an OFDM-based control channel signal onto a set of subcarriers of one or more of the OOK-ON symbols. The control channel component 1135 is capable of, configured to, or operable to support a means for transmitting the wake-up signal and OFDM-based control channel signal to the first UE.

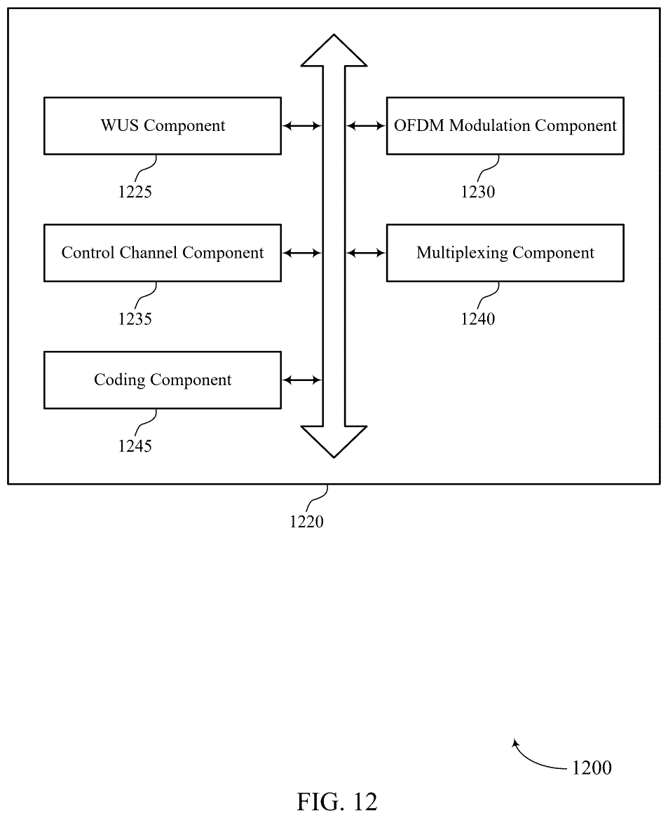

FIG. 12 shows a block diagram 1200 of a communications manager 1220 that supports wake-up signals with overlaid control channel for wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of wake-up signal with overlaid control channel for wireless communications as described herein. For example, the communications manager 1220 may include a WUS component 1225, an OFDM modulation component 1230, a control channel component 1235, a multiplexing component 1240, a coding component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The WUS component 1225 is capable of, configured to, or operable to support a means for generating a wake-up signal for at least a first UE, the wake-up signal using OOK modulation to indicate that the first UE is to transition from a lower power state to a higher power state, where the wake-up signal includes a set of multiple OOK symbols that include a set of multiple OOK-ON symbols and a set of multiple OOK-OFF symbols. The OFDM modulation component 1230 is capable of, configured to, or operable to support a means for modulating an OFDM-based control channel signal onto a set of subcarriers of one or more of the OOK-ON symbols. The control channel component 1235 is capable of, configured to, or operable to support a means for transmitting the wake-up signal and OFDM-based control channel signal to the first UE.

In some examples, to support modulating, the OFDM modulation component 1230 is capable of, configured to, or operable to support a means for modulating the set of subcarriers of one or more of the OOK-ON symbols with an encoded control channel signal, where a duration of each OOK-ON symbol corresponds to an OFDM symbol duration.

In some examples, the multiplexing component 1240 is capable of, configured to, or operable to support a means for time-domain multiplexing a control channel signal and a demodulation reference signal to generate a multiplexed control channel signal to be modulated onto the set of subcarriers of the one or more OOK-ON symbols.

In some examples, to support modulating, the coding component 1245 is capable of, configured to, or operable to support a means for encoding control channel information to generate a control channel signal. In some examples, to support modulating, the OFDM modulation component 1230 is capable of, configured to, or operable to support a means for modulating the control channel signal onto a set of wake-up signal subcarriers of the OOK-ON symbols, where a duration of each OOK-ON symbol is less than an OFDM symbol duration, and a subcarrier spacing on the set of wake-up signal subcarriers is based on a ratio between the duration of the OOK-ON symbols and the OFDM symbol duration.

In some examples, the OFDM-based control channel signal is provided as a SC-FDM waveform. In some examples, an OFDM symbol duration of the OFDM-based control channel signal is an integer multiple of an OOK symbol duration of the set of multiple OOK symbols, and the OFDM symbol duration and the OOK symbol duration provide for time alignment between the set of multiple OOK symbols of the wake-up signal and one or more other signals that are frequency division multiplexed with the wake-up signal.

In some examples, a duration of each OOK-ON symbol corresponds to an OFDM symbol duration, and the OFDM-based control channel signal is transmitted in one OFDM symbol or multiple consecutive OFDM symbols of consecutive OOK-ON symbols. In some examples, a duration of each OOK-ON symbol is less than an OFDM symbol duration, and the OFDM-based control channel signal is transmitted in one or more OOK-ON symbols.

In some examples, the OFDM-based control channel signal includes control information encoded in a set of CCEs that each include eleven RBs in one OOK-ON symbol duration, where each RB corresponds to a first quantity of subcarriers of one OON-ON symbol. In some examples, each CCE of the set of CCEs corresponds to time-frequency resources of one OOK-ON symbol in an allocated bandwidth of the wake-up signal without guard-band resources. In some examples, each CCE of the set of CCEs includes a REGs and first quantity of additional REs, and the first quantity of additional REs contain fewer REs than each REG, and where a quantity of REGs in each CCE is based on a quantity of RBs in one OOK-ON symbol. In some examples, a quantity of REs in each REG is based on the quantity of RBs in one OOK-ON symbol.

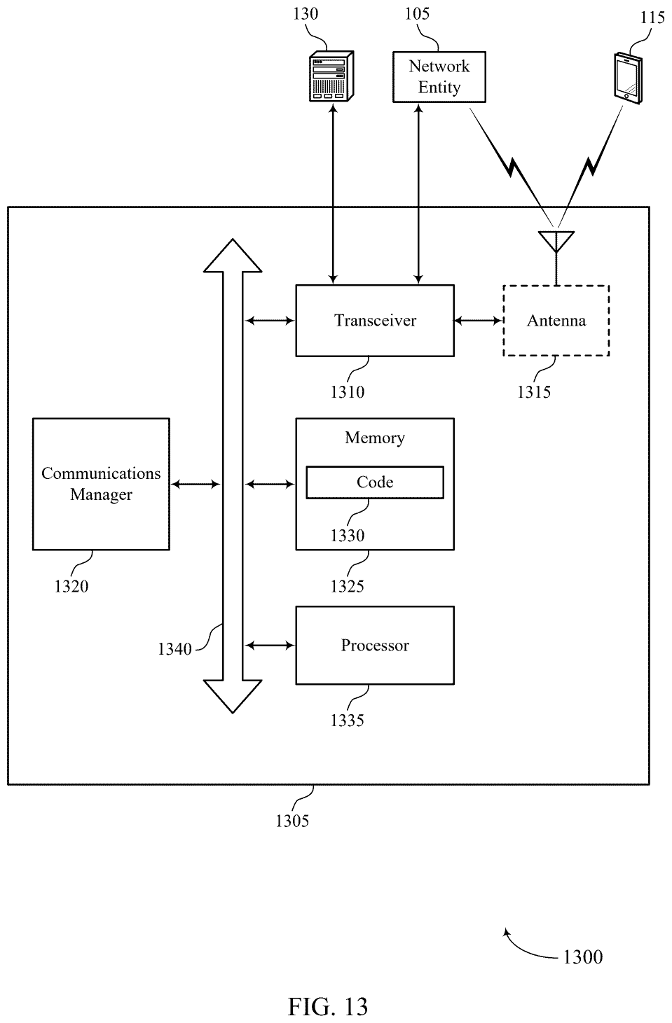

FIG. 13 shows a diagram of a system 1300 including a device 1305 that supports wake-up signals with overlaid control channel for wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting wake-up signal with overlaid control channel for wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for generating a wake-up signal for at least a first UE, the wake-up signal using OOK modulation to indicate that the first UE is to transition from a lower power state to a higher power state, where the wake-up signal includes a set of multiple OOK symbols that include a set of multiple OOK-ON symbols and a set of multiple OOK-OFF symbols. The communications manager 1320 is capable of, configured to, or operable to support a means for modulating an OFDM-based control channel signal onto a set of subcarriers of one or more of the OOK-ON symbols. The communications manager 1320 is capable of, configured to, or operable to support a means for transmitting the wake-up signal and OFDM-based control channel signal to the first UE.

By including or configuring the communications manager 1320 in accordance with examples as described herein, the device 1305 may support techniques for reduced latency, improved user experience related to reduced processing, reduced power consumption, more efficient utilization of communication resources, improved coordination between devices, and longer battery life.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of wake-up signal with overlaid control channel for wireless communications as described herein, or the at least one processor 1335 and the at least one memory 1325 may be otherwise configured to, individually or collectively, perform or support such operations.

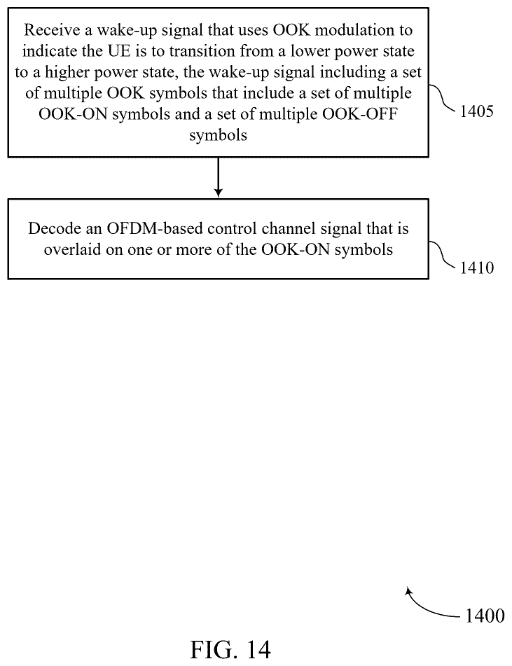

FIG. 14 shows a flowchart illustrating a method 1400 that supports wake-up signals with overlaid control channel for wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The operations of 1405 may be performed in accordance with examples as disclosed herein. In some examples, aspects of the operations of 1405 may be performed by a WUS component 825 as described with reference to FIG. 8.

At 1410, the method may include decoding an OFDM-based control channel signal that is overlaid on one or more of the OOK-ON symbols. The operations of 1410 may be performed in accordance with examples as disclosed herein. In some examples, aspects of the operations of 1410 may be performed by a control channel component 830 as described with reference to FIG. 8.

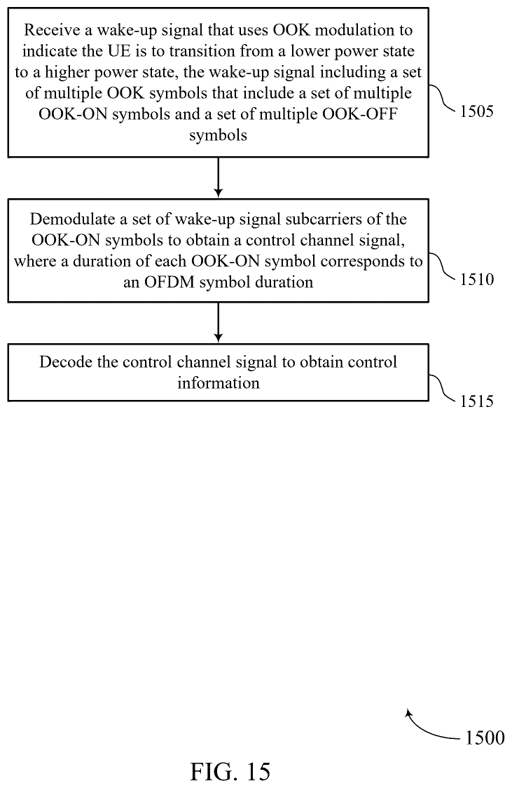

FIG. 15 shows a flowchart illustrating a method 1500 that supports wake-up signals with overlaid control channel for wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The operations of 1505 may be performed in accordance with examples as disclosed herein. In some examples, aspects of the operations of 1505 may be performed by a WUS component 825 as described with reference to FIG. 8.

At 1510, the method may include demodulating a set of wake-up signal subcarriers of the OOK-ON symbols to obtain a control channel signal, where a duration of each OOK-ON symbol corresponds to an OFDM symbol duration. The operations of 1510 may be performed in accordance with examples as disclosed herein. In some examples, aspects of the operations of 1510 may be performed by an OFDM demodulation component 835 as described with reference to FIG. 8.

At 1515, the method may include decoding the control channel signal to obtain control information. The operations of 1515 may be performed in accordance with examples as disclosed herein. In some examples, aspects of the operations of 1515 may be performed by a coding component 840 as described with reference to FIG. 8.

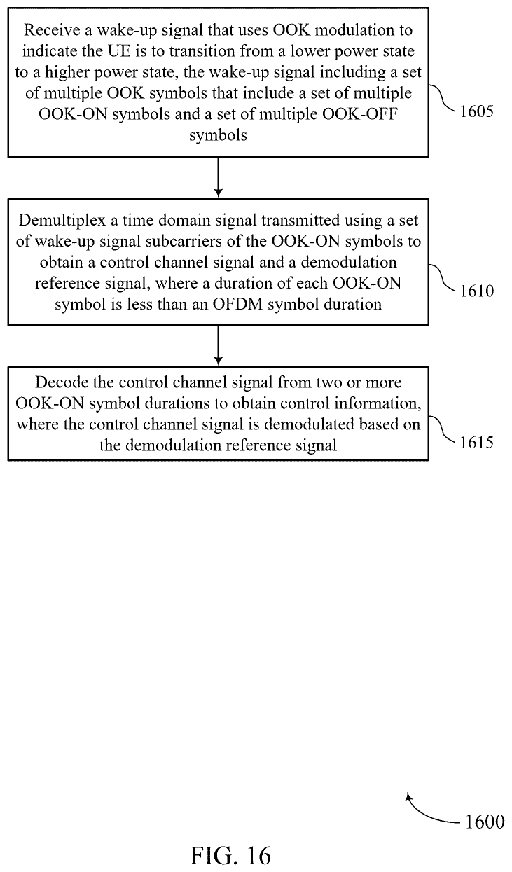

FIG. 16 shows a flowchart illustrating a method 1600 that supports wake-up signals with overlaid control channel for wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The operations of 1605 may be performed in accordance with examples as disclosed herein. In some examples, aspects of the operations of 1605 may be performed by a WUS component 825 as described with reference to FIG. 8.

At 1610, the method may include demultiplexing a time domain signal transmitted using a set of wake-up signal subcarriers of the OOK-ON symbols to obtain a control channel signal and a demodulation reference signal, where a duration of each OOK-ON symbol is less than an OFDM symbol duration. The operations of 1610 may be performed in accordance with examples as disclosed herein. In some examples, aspects of the operations of 1610 may be performed by a multiplexing component 845 as described with reference to FIG. 8.

At 1615, the method may include decoding the control channel signal from two or more OOK-ON symbol durations to obtain control information, where the control channel signal is demodulated based on the demodulation reference signal. The operations of 1615 may be performed in accordance with examples as disclosed herein. In some examples, aspects of the operations of 1615 may be performed by a coding component 840 as described with reference to FIG. 8.

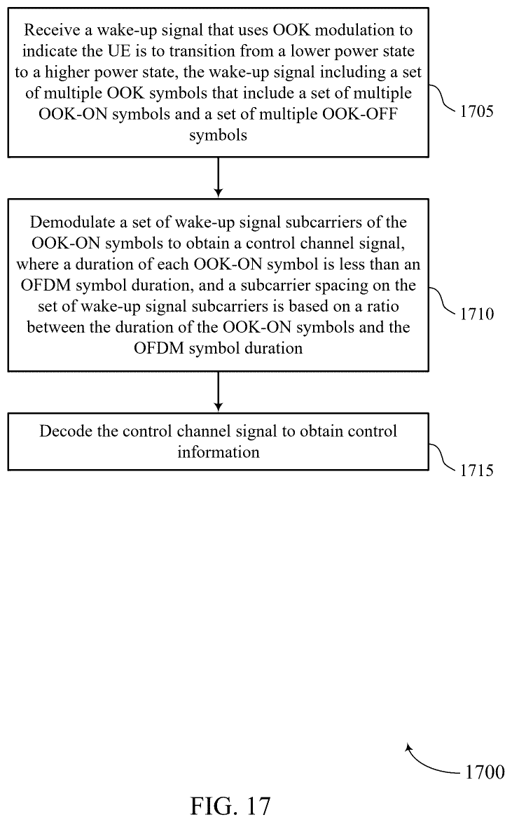

FIG. 17 shows a flowchart illustrating a method 1700 that supports wake-up signals with overlaid control channel for wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving a wake-up signal that uses OOK modulation to indicate the UE is to transition from a lower power state to a higher power state, the wake-up signal including a set of multiple OOK symbols that include a set of multiple OOK-ON symbols and a set of multiple OOK-OFF symbols. The operations of 1705 may be performed in accordance with examples as disclosed herein. In some examples, aspects of the operations of 1705 may be performed by a WUS component 825 as described with reference to FIG. 8.

At 1710, the method may include demodulating a set of wake-up signal subcarriers of the OOK-ON symbols to obtain a control channel signal, where a duration of each OOK-ON symbol is less than an OFDM symbol duration, and a subcarrier spacing on the set of wake-up signal subcarriers is based on a ratio between the duration of the OOK-ON symbols and the OFDM symbol duration. The operations of 1710 may be performed in accordance with examples as disclosed herein. In some examples, aspects of the operations of 1710 may be performed by an OFDM demodulation component 835 as described with reference to FIG. 8.

At 1715, the method may include decoding the control channel signal to obtain control information. The operations of 1715 may be performed in accordance with examples as disclosed herein. In some examples, aspects of the operations of 1715 may be performed by a coding component 840 as described with reference to FIG. 8.

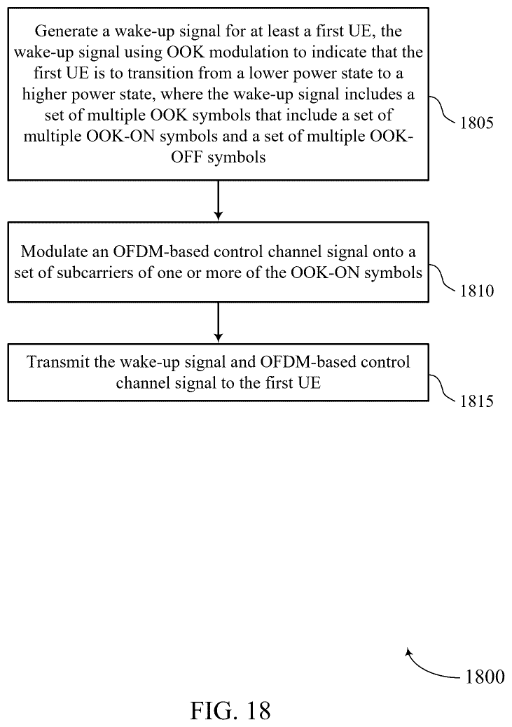

FIG. 18 shows a flowchart illustrating a method 1800 that supports wake-up signals with overlaid control channel for wireless communications in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include generating a wake-up signal for at least a first UE, the wake-up signal using OOK modulation to indicate that the first UE is to transition from a lower power state to a higher power state, where the wake-up signal includes a set of multiple OOK symbols that include a set of multiple OOK-ON symbols and a set of multiple OOK-OFF symbols. The operations of 1805 may be performed in accordance with examples as disclosed herein. In some examples, aspects of the operations of 1805 may be performed by a WUS component 1225 as described with reference to FIG. 12.

At 1810, the method may include modulating an OFDM-based control channel signal onto a set of subcarriers of one or more of the OOK-ON symbols. The operations of 1810 may be performed in accordance with examples as disclosed herein. In some examples, aspects of the operations of 1810 may be performed by an OFDM modulation component 1230 as described with reference to FIG. 12.

At 1815, the method may include transmitting the wake-up signal and OFDM-based control channel signal to the first UE. The operations of 1815 may be performed in accordance with examples as disclosed herein. In some examples, aspects of the operations of 1815 may be performed by a control channel component 1235 as described with reference to FIG. 12.

The following provides an overview of aspects of the present disclosure:

Aspect 1: A method for wireless communications at a UE, comprising: receiving a wake-up signal that uses OOK modulation to indicate the UE is to transition from a lower power state to a higher power state, the wake-up signal including a plurality of OOK symbols that include a plurality of OOK-ON symbols and a plurality of OOK-OFF symbols; and decoding an OFDM-based control channel signal that is overlaid on one or more of the OOK-ON symbols.

Aspect 2: The method of aspect 1, wherein the decoding comprises: demodulating a set of wake-up signal subcarriers of the OOK-ON symbols to obtain a control channel signal, wherein a duration of each OOK-ON symbol corresponds to an OFDM symbol duration; and decoding the control channel signal to obtain control information.

Aspect 3: The method of any of aspects 1 through 2, wherein the decoding comprises: demultiplexing a time domain signal transmitted using a set of wake-up signal subcarriers of the OOK-ON symbols to obtain a control channel signal and a demodulation reference signal, wherein a duration of each OOK-ON symbol is less than an OFDM symbol duration; and decoding the control channel signal from two or more OOK-ON symbol durations to obtain control information, wherein the control channel signal is demodulated based at least in part on the demodulation reference signal.

Aspect 4: The method of any of aspects 1 through 3, wherein the decoding comprises: demodulating a set of wake-up signal subcarriers of the OOK-ON symbols to obtain an OOK payload and a control channel signal, wherein a duration of each OOK-ON symbol is less than an OFDM symbol duration, and a subcarrier spacing on the set of wake-up signal subcarriers is based on a ratio between the duration of the OOK-ON symbols and the OFDM symbol duration; and decoding the control channel signal to obtain control information.

Aspect 5: The method of any of aspects 1 through 4, wherein the OFDM-based control channel signal is provided as a SC-FDM waveform.

Aspect 6: The method of any of aspects 1 through 2, wherein an OFDM symbol duration of the OFDM-based control channel signal is an integer multiple of an OOK symbol duration of the plurality of OOK symbols, and the OFDM symbol duration and the OOK symbol duration provide for time alignment between the plurality of OOK symbols of the wake-up signal and one or more other signals that are frequency division multiplexed with the wake-up signal.

Aspect 7: The method of any of aspects 1 through 2, wherein a duration of each OOK-ON symbol corresponds to an OFDM symbol duration, and the OFDM-based control channel signal is transmitted in one OFDM symbol or multiple consecutive OFDM symbols of consecutive OOK-ON symbols.

Aspect 8: The method of any of aspects 1 through 2, wherein a duration of each OOK-ON symbol is less than an OFDM symbol duration, and the OFDM-based control channel signal is transmitted in one or more OOK-ON symbols.

Aspect 9: The method of any of aspects 1 through 8, wherein the OFDM-based control channel signal includes control information encoded in a set of CCEs that each include eleven RBs in one OOK-ON symbol duration, wherein each RB corresponds to a first quantity of subcarriers of one OON-ON symbol.

Aspect 10: The method of aspect 9, wherein each CCE of the set of CCEs corresponds to time-frequency resources of one OOK-ON symbol in an allocated bandwidth of the wake-up signal without guard-band resources.

Aspect 11: The method of any of aspects 9 through 10, wherein each CCE of the set of CCEs includes a set of REGs and first quantity of additional REs, and the first quantity of additional REs contain fewer REs than each REG, and wherein a quantity of REGs in each CCE is based at least in part on a quantity of RBs in one OOK-ON symbol.

Aspect 12: The method of aspect 11, wherein a quantity of REs in each REG is based at least in part on the quantity of RBs in one OOK-ON symbol.

Aspect 13: A method for wireless communications at a network entity, comprising: generating a wake-up signal for at least a first UE, the wake-up signal using OOK modulation to indicate that the first UE is to transition from an idle state to an active state, wherein the wake-up signal includes a plurality of OOK symbols that include a plurality of OOK-ON symbols and a plurality of OOK-OFF symbols; modulating an OFDM-based control channel signal onto a set of subcarriers of one or more of the OOK-ON symbols; and transmitting the wake-up signal and OFDM-based control channel signal to the first UE.

Aspect 14: The method of aspect 13, wherein the modulating comprises: modulating the set of subcarriers of one or more of the OOK-ON symbols with a control channel signal, wherein a duration of each OOK-ON symbol corresponds to an OFDM symbol duration.

Aspect 15: The method of any of aspects 13 through 14, further comprising: time-domain multiplexing a control channel signal and a demodulation reference signal to generate a multiplexed control channel signal to be modulated onto the set of subcarriers of the one or more OOK-ON symbols.

Aspect 16: The method of any of aspects 13 through 15, wherein the modulating comprises: encoding control channel information to generate a control channel signal; modulating the control channel signal onto a set of wake-up signal subcarriers of the OOK-ON symbols, wherein a duration of each OOK-ON symbol is less than an OFDM symbol duration, and a subcarrier spacing on the set of wake-up signal subcarriers is based on a ratio between the duration of the OOK-ON symbols and the OFDM symbol duration

Aspect 17: The method of any of aspects 13 through 16, wherein the OFDM-based control channel signal is provided as a SC-FDM waveform.

Aspect 18: The method of any of aspects 13 through 14, wherein an OFDM symbol duration of the OFDM-based control channel signal is an integer multiple of an OOK symbol duration of the plurality of OOK symbols, and the OFDM symbol duration and the OOK symbol duration provide for time alignment between the plurality of OOK symbols of the wake-up signal and one or more other signals that are frequency division multiplexed with the wake-up signal.

Aspect 19: The method of any of aspects 13 through 14, wherein a duration of each OOK-ON symbol corresponds to an OFDM symbol duration, and the OFDM-based control channel signal is transmitted in one OFDM symbol or multiple consecutive OFDM symbols of consecutive OOK-ON symbols.

Aspect 20: The method of any of aspects 13 through 14, wherein a duration of each OOK-ON symbol is less than an OFDM symbol duration, and the OFDM-based control channel signal is transmitted in one or more OOK-ON symbols.

Aspect 21: The method of any of aspects 13 through 20, wherein the OFDM-based control channel signal includes control information encoded in a set of CCEs that each include eleven RBs in one OOK-ON symbol duration, wherein each RB corresponds to a first quantity of subcarriers of one OON-ON symbol.

Aspect 22: The method of aspect 21, wherein each CCE of the set of CCEs corresponds to time-frequency resources of one OOK-ON symbol in an allocated bandwidth of the wake-up signal without guard-band resources.

Aspect 23: The method of any of aspects 21 through 22, wherein each CCE of the set of CCEs includes a set of REGs and first quantity of additional REs, and the first quantity of additional REs contain fewer REs than each REG, and wherein a quantity of REGs in each CCE is based at least in part on a quantity of RBs in one OOK-ON symbol.

Aspect 24: The method of aspect 23, wherein a quantity of REs in each REG is based at least in part on the quantity of RBs in one OOK-ON symbol.

Aspect 25: A UE for wireless communications, comprising one or more memories storing processor-executable code, and one or more processors coupled with the one or more memories and individually or collectively operable to execute the code to cause the UE to perform a method of any of aspects 1 through 12.

Aspect 26: A UE for wireless communications, comprising at least one means for performing a method of any of aspects 1 through 12.

Aspect 27: A non-transitory computer-readable medium storing code for wireless communications, the code comprising instructions executable by one or more processors to perform a method of any of aspects 1 through 12.

Aspect 28: A network entity for wireless communications, comprising one or more memories storing processor-executable code, and one or more processors coupled with the one or more memories and individually or collectively operable to execute the code to cause the network entity to perform a method of any of aspects 13 through 24.

Aspect 29: A network entity for wireless communications, comprising at least one means for performing a method of any of aspects 13 through 24.

Aspect 30: A non-transitory computer-readable medium storing code for wireless communications, the code comprising instructions executable by one or more processors to perform a method of any of aspects 13 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” T

he term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a wake-up signal that uses on-off keying (OOK) modulation to indicate the UE is to transition from a lower power state to a higher power state, the wake-up signal including a plurality of OOK symbols that include a plurality of OOK-ON symbols and a plurality of OOK-OFF symbols; and
decode an orthogonal frequency division multiplexing (OFDM)-based control channel signal that is overlaid on one or more of the OOK-ON symbols.

2. The UE of claim 1, wherein, to decode the OFDM-based control channel signal, the one or more processors are individually or collectively operable to execute the code to cause the UE to:
demodulate a set of wake-up signal subcarriers of the OOK-ON symbols to obtain a control channel signal, wherein a duration of each OOK-ON symbol corresponds to an OFDM symbol duration; and
decode the control channel signal to obtain control information.

3. The UE of claim 1, wherein, to decode the OFDM-based control channel signal, the one or more processors are individually or collectively operable to execute the code to cause the UE to:
demultiplex a time domain signal transmitted using a set of wake-up signal subcarriers of the OOK-ON symbols to obtain a control channel signal and a demodulation reference signal, wherein a duration of each OOK-ON symbol is less than an OFDM symbol duration; and
decode the control channel signal from two or more OOK-ON symbol durations to obtain control information, wherein the control channel signal is demodulated based at least in part on the demodulation reference signal.

4. The UE of claim 1, wherein, to decode the OFDM-based control channel signal, the one or more processors are individually or collectively operable to execute the code to cause the UE to:
demodulate a set of wake-up signal subcarriers of the OOK-ON symbols to obtain an OOK payload and a control channel signal, wherein a duration of each OOK-ON symbol is less than an OFDM symbol duration, and a subcarrier spacing on the set of wake-up signal subcarriers is based on a ratio between the duration of the OOK-ON symbols and the OFDM symbol duration; and
decode the control channel signal to obtain control information.

5. The UE of claim 1, wherein the OFDM-based control channel signal is provided as a single carrier (SC) frequency division multiplexing (FDM) waveform.

6. The UE of claim 1, wherein an OFDM symbol duration of the OFDM-based control channel signal is an integer multiple of an OOK symbol duration of the plurality of OOK symbols, and the OFDM symbol duration and the OOK symbol duration provide for time alignment between the plurality of OOK symbols of the wake-up signal and one or more other signals that are frequency division multiplexed with the wake-up signal.

7. The UE of claim 1, wherein:
a duration of each OOK-ON symbol corresponds to an OFDM symbol duration, and the OFDM-based control channel signal is transmitted in one OFDM symbol or multiple consecutive OFDM symbols of consecutive OOK-ON symbols.

8. The UE of claim 1, wherein a duration of each OOK-ON symbol is less than an OFDM symbol duration, and the OFDM-based control channel signal is transmitted in one or more OOK-ON symbols.

9. The UE of claim 1, wherein the OFDM-based control channel signal includes control information encoded in a set of control channel elements (CCEs) that each include eleven resource blocks (RBs) in one OOK-ON symbol duration, wherein each RB corresponds to a first quantity of subcarriers of one OON-ON symbol.

10. The UE of claim 9, wherein each CCE of the set of CCEs corresponds to time-frequency resources of one OOK-ON symbol in an allocated bandwidth of the wake-up signal without guard-band resources.

11. The UE of claim 9, wherein each CCE of the set of CCEs includes a set of resource element groups (REGs) and first quantity of additional resource elements (REs), and the first quantity of additional REs contain fewer REs than each REG, and wherein a quantity of REGs in each CCE is based at least in part on a quantity of RBs in one OOK-ON symbol.

12. The UE of claim 11, wherein a quantity of REs in each REG is based at least in part on the quantity of RBs in one OOK-ON symbol.

13. A method for wireless communications at a user equipment (UE), comprising:
receiving a wake-up signal that uses on-off keying (OOK) modulation to indicate the UE is to transition from a lower power state to a higher power state, the wake-up signal including a plurality of OOK symbols that include a plurality of OOK-ON symbols and a plurality of OOK-OFF symbols; and
decoding an orthogonal frequency division multiplexing (OFDM)-based control channel signal that is overlaid on one or more of the OOK-ON symbols.

14. The method of claim 13, wherein the decoding comprises:
demodulating a set of wake-up signal subcarriers of the OOK-ON symbols to obtain a control channel signal, wherein a duration of each OOK-ON symbol corresponds to an OFDM symbol duration; and
decoding the control channel signal to obtain control information.

15. The method of claim 13, wherein the decoding comprises:
demodulating a set of wake-up signal subcarriers of the OOK-ON symbols to obtain an OOK payload and a control channel signal, wherein a duration of each OOK-ON symbol is less than an OFDM symbol duration, and a subcarrier spacing on the set of wake-up signal subcarriers is based on a ratio between the duration of the OOK-ON symbols and the OFDM symbol duration; and
decoding the control channel signal to obtain control information.

16. The method of claim 13, wherein the OFDM-based control channel signal includes control information encoded in a set of control channel elements (CCEs) that each include eleven resource blocks (RBs) in one OOK-ON symbol duration, wherein each RB corresponds to a first quantity of subcarriers of one OON-ON symbol.

17. The method of claim 16, wherein each CCE of the set of CCEs includes a set of resource element groups (REGs) and first quantity of additional resource elements (REs), and the first quantity of additional REs contain fewer REs than each REG, and wherein a quantity of REGs in each CCE is based at least in part on a quantity of RBs in one OOK-ON symbol.

18. A non-transitory computer-readable medium storing code for wireless communications, the code comprising instructions executable by one or more processors to:
receive a wake-up signal that uses on-off keying (OOK) modulation to indicate a UE is to transition from a lower power state to a higher power state, the wake-up signal including a plurality of OOK symbols that include a plurality of OOK-ON symbols and a plurality of OOK-OFF symbols; and
decode an orthogonal frequency division multiplexing (OFDM)-based control channel signal that is overlaid on one or more of the OOK-ON symbols.

19. The non-transitory computer-readable medium of claim 18, wherein the instructions to decode the OFDM-based control channel signal are executable by the one or more processors to:
demultiplex a time domain signal transmitted using a set of wake-up signal subcarriers of the OOK-ON symbols to obtain a control channel signal and a demodulation reference signal, wherein a duration of each OOK-ON symbol is less than an OFDM symbol duration; and
decode the control channel signal from two or more OOK-ON symbol durations to obtain control information, wherein the control channel signal is demodulated based at least in part on the demodulation reference signal.

20. The non-transitory computer-readable medium of claim 18, wherein an OFDM symbol duration of the OFDM-based control channel signal is an integer multiple of an OOK symbol duration of the plurality of OOK symbols, and the OFDM symbol duration and the OOK symbol duration provide for time alignment between the plurality of OOK symbols of the wake-up signal and one or more other signals that are frequency division multiplexed with the wake-up signal.
